(19) United States
(12) Patent Application Publication
(10) Pub. No.: US 2014/0246145 A1
(43) Pub. Date: Sep. 4, 2014

(54) METHOD FOR TAPE LAYING AND CONSOLIDATION UPON DEPOSITION OF A THERMOPLASTIC COMPOSITE WORKPIECE WITH FIBER REINFORCEMENT

(71) Applicant: Didier Kurtz, Pornic (FR)

(72) Inventor: Didier Kurtz, Pornic (FR)

(73) Assignee: DAHER AEROSPACE, Saint Julien De Chedon (FR)

(21) Appl. No.: 14/130,041

(22) PCT Filed: Jul. 2, 2012
(86) PCT No.: PCT/EP2012/062862

§ 371 Date: Apr. 9, 2014

(30) Foreign Application Priority Data
Jul. 1, 2011 (FR) 1155982

(51) Int. Cl. B32B 37/06

(52) U.S. Cl. CPC B32B 37/06; B32B 2305/10; B32B 2309/02
USPC 156/244.23

(57) ABSTRACT

A method for laying up a tape of fibers comprising a thermoplastic polymer and the consolidation upon deposition of a workpiece thus laid up. The method comprises the steps of pre-consolidating a tape of fibers pre-impregnated with a thermoplastic polymer by pultruding strands pre-impregnated with the thermoplastic polymer through a die. The pre-consolidated tape is stored in the form of a semi-finished product. The semi-finished product is tape laid on a ply of the same nature that is first deposited on a tooling by pressing the semi-finished product on the ply. The interface between the semi-finished product and the ply first deposited is heated to a temperature T, capable of welding the semi-finished product on the ply.

The invention relates to a method for the tape laying and consolidation upon deposition of a composite thermoplastic workpiece with fiber reinforcement.

Automated tape laying, by depositing tapes or placing pre-impregnated fibers, is a manufacturing method that is very widespread in the area of the making of composite parts with fiber reinforcement in a thermosetting matrix. That is because the tack and fluidity of these resins make it possible to achieve a workpiece quality that is free of hollows and porosities during subsequent deposition and curing operations. With tapes so-called pre-impregnated with a thermoplastic polymer, said polymer does not show tack at the tape laying temperature. The ‘pre-impregnation’ is in practice carried out either by calendering a film made up of said polymer on said tapes of fiber or by powder-coating said fibers or by inserting polymer fibers mixed together with the reinforcing fibers. Unless otherwise indicated, the terms ‘pre-impregnation’ and ‘pre-impregnated’ in relation to fibers and a thermoplastic polymer must be understood in the practical meaning set out above. The plies that are successively deposited are joined to each other by melting the polymer. But the melted thermoplastic polymer is characterized by a very high viscosity, often of several orders of magnitude compared to uncured thermosetting resins. Thus, even when the polymer charge contained in the fibrous tape is melted, it is very difficult to obtain effective impregnation of all the plies deposited. Further, while the viscosity of the melted polymer can be reduced by increasing the temperature, generally beyond the melting temperature, the polymer then swells significantly and is difficult to control in a dynamic deposition process. As a result, hollows or porosities remain in the stack, all the more so when the depositing speed, or more precisely the output rate of deposited material, is high. Thus, even though the thermoplastic polymer does not require curing to achieve its mechanical properties, it is however necessary to consolidate the stratification obtained by tape laying in order to obtain a finished part that meets the requirements of the structural applications of such a part. Such consolidation consists in raising the temperature of the stratification obtained by tape laying to the melting temperature of the polymer, while maintaining the thickness of the workpiece by pressurizing means, generally in an autoclave. Thus, making the polymer melt again and subjecting it to the pressure effect allow the compacting of the whole and eliminate hollows and porosities from said stratification. Additionally, because of the swelling of the polymer when it is melted, the workpiece only reaches its final thickness after the compacting operation that is subsequent to tape laying, and that operation makes it necessary to implement means such as caul plates that make it possible to obtain a uniform thickness of the workpiece and the required surface condition of its sides. That compacting operation is carried out at the melting temperature of the thermoplastic polymer, and that temperature is generally significantly higher than the curing temperatures of thermosetting resins. The operation involves the use of means such as autoclaves, tools and consumables, particularly to achieve sealing, and their cost is high.

All the devices known from prior art, and for example the device and method described in the document EP-1 911 569-B1, approach the problem of consolidation, called in situ consolidation, that is to say during the deposition of fibrous tapes pre-impregnated with a thermoplastic polymer, by searching for a method to heat and subject to pressure as evenly as possible the tape being deposited and the pre-deposited plies. Thus, the making of a workpiece in a quality that is free of porosities relies on complex heating and pressure application devices that make it possible to keep the deposited layers at sufficient temperature and pressure for a time that is sufficient to allow the uniform impregnation of the plies. Thus, the results are obtained at the price of complex devices and at the cost of efficiency. Even with such complexity, these methods are in practice limited in terms of the maximum thicknesses that can thus be deposited and consolidated in situ and the industrial experience of the applicant shows that it is not possible, in industrial production conditions, to use these methods to achieve stratifications with over 8 stacked plies that meet the requirements for Class 2F structural parts in the field of aeronautics.

The document “Manufacturing processes for advanced composites” Chapter 10, Elsevier Advanced Technology of 1 Jan. 2004, confirms that these in situ consolidation methods of a stratification of plies pre-impregnated with a thermoplastic polymer do not make it possible to achieve, in industrial conditions, consolidation rates above 90% and that a post-consolidation step is required, particularly using a compacting plate, after drape forming.

The invention is aimed at remedying the drawbacks of the prior art and to that end, it discloses a method for tape laying a tape of fibers comprising a thermoplastic polymer and for consolidation during deposition of a workpiece that is made by tape laying in that manner, said method comprising the steps of:
a. pre-consolidating a tape of fibers pre-impregnated with the thermoplastic polymer;
b. storing said pre-consolidated tape in the form of a semi-finished product;
c. tape laying said the semi-finished product on a ply of the same nature that is first deposited on a shape by pressing said semi-finished product on said ply and heating the interface between the semi-finished product and the ply first deposited to a temperature T, capable of welding the semi-finished product on said ply.

Thus, pre-consolidation makes it possible to obtain a tape of fibers that is free of defects such as porosities, by eliminating the air blocked in said fibers and at their joins, and to evenly impregnate the fibers of said tape, further making it possible to increase the polymer surface exposed to welding during the tape laying operation. Thus, the method in the invention does not make it necessary to melt the totality of the polymer included in the pre-consolidated tape and the polymer included in the plies deposited earlier, but merely to raise the temperature of the interface between the two to a temperature allowing welding at said interface; that temperature is approximately the melting temperature of the material and is less constraining in terms of viscosity than the temperature allowing the impregnation of the fibers during consolidation. The term welding means the joint melting of at least one surface layer of each of the elements (tape and pre-deposited ply) assembled in that manner. In addition to the benefit of in situ consolidation, these conditions allow rapid depositing with simple means, allowing the making of complex shapes and/or the use of wide tapes to obtain tape laying mass rates comparable with those obtained with thermosetting resins impregnated plies. In the absence of high-temperature consolidation at the end of tape laying, the costs of tooling, installation and consumables are reduced.

The invention can be implemented according to the advantageous embodiments described below, which may be considered individually or in any technically operative combination.

Advantageously, step (a) is carried out by pultruding strands pre-impregnated with thermoplastic polymer through a die. Thus, the pultrusion method allows the dynamic and rapid pre-consolidation of the pre-impregnated fiber tape and further allows the sizing of the thickness and width of the tape. Passage through a die thus makes it possible to press the slivers of pre-impregnated strands and obtain the even distribution of resin while eliminating the air included in the strands.

Advantageously, the pre-consolidation of step (a) is carried out at a temperature T1 higher than the melting temperature of the thermoplastic polymer. Thus, the fluidity of the polymer allows the perfect impregnation of the fibers.

Advantageously, the semi-finished product is stored in step (b) in the form of a roll that can be installed and paid out by a tape laying machine during step (c). The polymer tape is sufficiently fine to lend itself to this packaging mode, which uses a natural tendency of the tape, particularly at the delivery from pultrusion, of rolling up on itself at the end of dynamic consolidation.

In one particular embodiment, the thermoplastic polymer is a polyetheretherketone (PEEK), T1=400° C. and T is equal to the crystalline melting temperature of the polymer. Thus, the method according to the invention makes it possible to create, through tape laying and in situ consolidation, workpieces made of composite with continuous fiber reinforcement in such a high performance matrix without requiring means, such as a stove or autoclave, capable of consolidating the piece at high temperature.

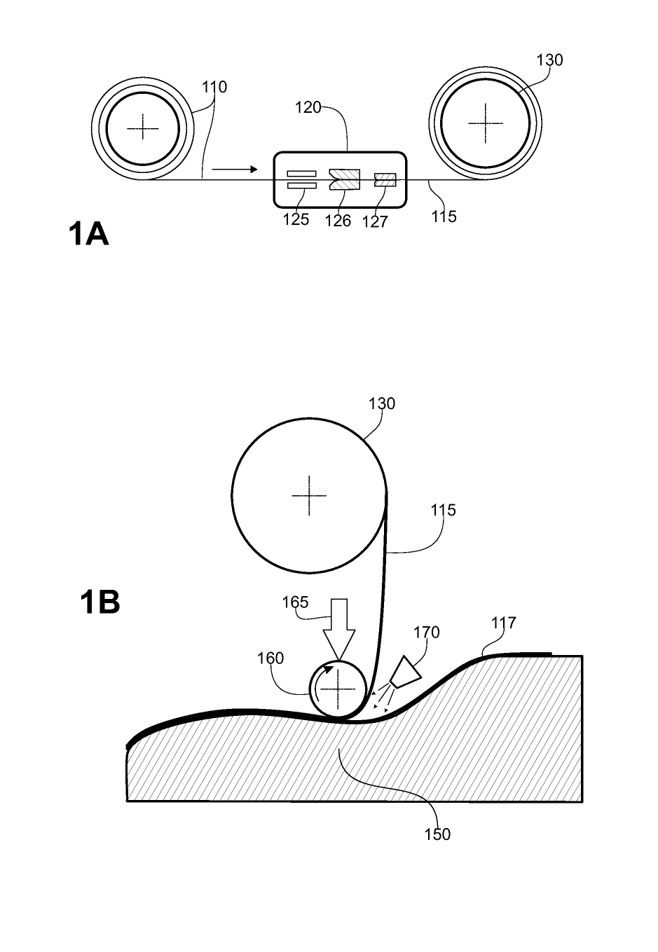

The invention is described below in its preferred embodiments, which are not limitative in any way, and by reference to FIGS. 1A and 1B wherein:

FIG. 1A is a side view of a principle diagram of the operation of pre-consolidation by pultrusion of a fibrous tape pre-impregnated with a thermoplastic polymer according to an exemplary embodiment of the method according to the invention; and

FIG. 1B is a side view of a principle diagram of the performance of a tape laying operation according to an exemplary embodiment of the invention.

In FIG. 1A, during a first step of the method according to the invention, strands (110) made up of fibers, for example carbon fibers, pre-impregnated with a thermoplastic polymer, for example polyetheretherketone or PEEK, are pre-consolidated during a dynamic process (120), for example pultrusion. Such a pultrusion process is known from prior art and consists, in one non-limitative exemplary embodiment, in raising the temperature of said strands (110) pre-impregnated by film wrapping, powder-coating or commingled with polymer strands to a temperature close to the melting temperature of said polymer, for example when said strands are passed in an infrared heating device (125). If the thermoplastic polymer is made of PEEK, that first heating operation raises the temperature of said strands to a temperature ranging between 300° C. and the crystalline melting temperature of said polymer, i.e. about 360° C. depending on the grade of PEEK used. The strands are then passed through a first die (126) called the hot die, raised to a temperature that is sufficient for the fluidity of the melted polymer to impregnate the strands regularly. For PEEK, that temperature T1 typically ranges between the crystalline melting temperature and 400° C., so that T1 is preferably set to 400° C. Said die has a variable gap that makes it possible to gradually form the strands into an impregnated web with a definite thickness and width, which web is then introduced in a cooling and sizing die (127). The consolidated web (115) at the outlet of the sizing die is thin (1 ply) and sufficiently flexible to be wound on a storage roller (130) with an appropriate diameter. The web thus pre-consolidated is stable and can be stored indefinitely at ambient temperature in the form of a semi-finished product. Thus, the semi-finished product (115) can be manufactured in very large runs, using continuous manufacturing methods in dedicated factories or production units, distant and independent from the tape laying units.

In FIG. 1B, the composite workpiece is manufactured by tape laying, by placing the roll of semi-finished product (130) in a tape laying machine. Tape laying is carried out using tooling (150) sculpted to the shape of the workpiece to make. Such a tape laying machine, capable of implementing the said semi-finished product, is known in the prior art and its deposition principle has been described in a non-limitative example in document FR-2 950 285-A1. Such a tape laying machine adapted to the implementation of the method according to the invention comprises:
means to receive and pay out the roll (130) of semi-finished product (115);
pressure means (160) capable of applying pressure (165) on the semi-finished product (115) during tape laying;
heating means (170) capable of heating the interface between the semi-finished product (115) being deposited and the ply (117) deposited earlier.

The heating means (170) are designed to raise the temperature of that interface to a T temperature, enabling the welding the pre-consolidated semi-finished product on the ply (117) already deposited, this ply being itself pre-consolidated. This temperature is close to the crystalline melting temperature of the thermoplastic polymer, i.e. about 360° C. for the PEEK depending on the grade used.

The first pre-consolidate ply, deposited on the tooling may, for example, be deposited in the same way on a removable fabric, for example a glass fabric, which glass fabric may be held on the tooling by adhesives or by a vacuum device. The plies are thus deposited by tape laying according to the definite orientations until the desired stratification is obtained. The finished piece can then be unmolded and does not require a subsequent consolidation. Thus, the tooling (150) used does not require high-temperature resistance, or the management of differential dilatation between the tooling and the workpiece during said consolidation step.

The description and the exemplary embodiments above show that the invention achieves its objectives, in particular it makes it possible to make a finished piece comprising a continuous fiber reinforcement in a thermoplastic matrix directly by tape laying.

1. A method for laying up a tape of fibers comprising a thermoplastic polymer and consolidation upon deposition of a workpiece thus laid up, comprising the steps of:
a. pre-consolidating a tape of fibers pre-impregnated with the thermoplastic polymer by pultruding strands pre-impregnated with the thermoplastic polymer through a die;
b. storing said pre-consolidated tape in the form of a semi-finished product;
c. tape laying said semi-finished product on a ply of the same nature that is first deposited on a tooling by pressing said semi-finished product on said ply and heating the interface between the semi-finished product and the ply first deposited to a temperature T, capable of welding the semi-finished product on said ply.

2. A method according to claim 1, wherein the pre-consolidation of step (a) is carried out at a temperature T1 higher than the melting temperature of the thermoplastic polymer.

3. A method according to claim 1, wherein the semi-finished product is stored in step (b) in the form of a roll that can be installed and paid out by a tape laying machine during step (c).

4. A method according to claim 2, wherein the thermoplastic polymer is a polyetheretherketone (PEEK), and T1=400° C. and T is equal to the crystalline melting temperature of the polymer.
